(19) United States
(12) Patent Application Publication
(10) Pub. No.: US 2010/0008104 A1
(43) Pub. Date: Jan. 14, 2010

(54) POINT HOLDER

(76) Inventor: Horst ROSENTHAL, Waldbroel (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(21) Appl. No.: 12/418,832

(22) Filed: Apr. 6, 2009

(30) Foreign Application Priority Data
Jul. 12, 2008 (DE) 20 2008 009 391.0

(51) Int. Cl. F21V 21/00; F21V 7/04

(52) U.S. Cl. 362/634; 362/600

(57) ABSTRACT

A point holder, for a glass panel provided with holes, has a first mounting part reaching over a front edge of the glass panel hole in an installed position, a second mounting part reaching over a rear edge of the glass panel hole and, where appropriate, a housing part located at least partly in the glass panel hole. A mounting device is provided for load-transmitting fastening of the point holder on a supporting structure. The point holder has an electro-optical device, at least a partial area of which is located on or between the first and second mounting parts, and by which energy and/or signals can be coupled into the glass panel and/or the area around the point holder, and an electro-optical supply line. The first or second mounting part, or both mounting parts, have a lead-through for the supply line located outside the load-transmitting mounting device.

### BACKGROUND OF THE INVENTION

The invention relates to a point holder for a glass panel provided with holes, having a first mounting part reaching over a front edge of the glass panel hole in the installed position, a second mounting part reaching over a rear edge of the glass panel hole and, where appropriate, a housing part located at least partly in the glass panel hole, where a mounting device is provided for load-transmitting fastening of the point holder on a supporting structure, and having an electro-optical device, at least a partial area of which is located on or between the first and second mounting parts, and by which energy and/or signals can be coupled into the glass panel and/or the area around the point holder, and which has an electro-optical supply line.

Generic point holders are known, where the opto-electronic device can be a lighting device with several lamps, such as LEDs, which, for example, radiate light from the narrow side into the glass panel to be mounted, such that the glass panel as a whole then emits light and is illuminated owing to the total reflection of the light occurring on the glass panel surfaces. Also known are opto-electronic devices in the form of heating foils, which can be located between the individual panels of a laminated glass panel. The electro-optical device is then essentially located within the glass panel and in the axial direction of the mounting device, between the first and second mounting parts.

With generic point holders, there is often the problem, when fixing the glass panel, of having to compensate for slight angular or fit tolerances that may, for example, be present as a result of tolerances of the supporting structure or the manner of fastening the mounting device to the supporting structure. This is intended to avoid stresses within the glass panel when it is fastened to the point holder, since such stresses could lead to the glass panel being damaged. It must moreover be ensured that the electro-optical supply line is not damaged in the event of movement of the supporting structure relative to the point holder or during assembly of the point holder.

Moreover, generic point holders are frequently for use in damp rooms or outdoors, meaning that the problem of moisture penetrating the point holder often arises, this possibly leading to malfunctions in the electro-optical device. In this context, tightness of the point holder is to be guaranteed, especially regardless of the position of the articulated joint between the mounting device and the first and/or second mounting part of the point holder.

Furthermore, it should also be easy to install the point holder on different supporting structures, including in the case of overhead installation, for example. However, it must then always be ensured that the electro-optical supply line is not damaged or does not tear off from the electro-optical device.

### BRIEF SUMMARY OF THE INVENTION

The object of the invention is thus to provide a point holder that enables dependable sealing off of the supply line of the electro-optical device, regardless of the position of the mounting device relative to the supporting structure, and that is easy to install.

According to the invention, this object is achieved by a point holder on which the first and/or the second mounting part has a lead-through for the supply line, which is located outside the load-transmitting mounting device. As a result, it is no longer necessary to pass the supply line through the mounting device itself and feed it to the electro-optical device. The point holder can consequently be used flexibly and independently of the supporting structure, e.g., even if the electro-optical supply line cannot readily be passed through the supporting structure in order to be fed through a feed-through channel in the mounting device to the electro-optical device. This can be the case if, for example, the supporting structure is of particularly solid design, e.g., in the form of a solid concrete wall, or not to be penetrated by a through-hole for the supply line for other reasons. Moreover, damage to the electro-optical supply line during installation of the mounting device on the supporting structure is avoided, since the connection to an external supply line can be made independently of installation of the point holder.

For the purposes of the invention, the opto-electronic device is an optical and/or electrical device, including a lighting device that can comprise one or more LEDs or other light sources, an electrical device, such as a heating and/or luminescent foil, located between two glass panels of a laminated glass panel, or similar. The opto-electronic device within the meaning of the invention can, in the broadest sense, also be an electrical supply line or contact to an energy and/or signal source located within the glass panel, e.g., a light or heat source, such as a corresponding foil, e.g., a heating and/or luminescent foil, LEDs, etc., which can be located between the individual panels of a laminated or compound glass panel. The electro-optical device can be integrated in the point holder, i.e., an integral element of the point holder, such that it can be mounted on the glass panel together with the point holder. The point holder with electro-optical device can constitute an assembly that can be handled as a single unit. The electro-optical device is preferably located between the first and second mounting parts within the point holder, or at least partly accommodated by the first and/or second mounting part. The electro-optical device is preferably designed in such a way that, when the point holder is mounted on the glass panel, it can couple electrical and/or optical energy and/or signals into the glass panel and, where appropriate, alternatively or additionally also emit or radiate electrical and/or optical energy or signals from the point holder into the area around the point holder, e.g., via the first and/or second mounting part. The supply line of the electro-optical device can thus be an electrical and/or optical supply line, e.g., one or more electrically conductive cables, one or more optical waveguides, e.g., fiber optic cables, or the like, including combinations thereof.

At least in a final locking state, the mounting device is preferably designed in articulated fashion relative to at least one of the mounting parts, particularly the second mounting part, where the electro-optical supply line is located outside the articulated joint. As a result, the electro-optical supply line is independent of any movement of the mounting device relative to the respective mounting part. Furthermore, this means that sealing off from the supply line or its lead-through is possible independently of the articulated joint and its location or joint position and/or also independently of the fastening area of the mounting device on the corresponding component of the point holder, e.g., the first and/or second mounting part. Furthermore, this permits sealing off of the supply line lead-through independently of any locking means of the articulated joint between the mounting device and one of the mounting parts or the housing part, e.g., independently of locking means acting on the joint element in the axial direction of the mounting device. As a result, the point holder with opto-electronic supply line can be used particularly flexibly on the whole, and damage to the supply line during movement of the articulated joint is virtually ruled out. Moreover, this makes it possible to achieve particularly reliable tightness, especially water-tightness, of the supply line lead-through by simple means.

The lead-through of the supply line from the electro-optical device, through an area of the point holder to the outside, e.g., through the second mounting part, is preferably of water-tight design, this preferably also being true if the supply line is routed in a lead-through in the manner of a cable duct. This prevents not only the penetration of water or moisture from the area surrounding the point holder into the point holder, but also the penetration of moisture through the supply line lead-through itself. For the purposes of the invention, the term “water-tight” sealing is generally to be taken to mean sealing against splash water and/or standing water and/or water vapor or humid air.

The opto-electronic device can have a housing with an integrally molded area that leads to the outside on the point holder, preferably in water-tight fashion. A section of the supply line is preferably routed to the outside of the point holder that can be encapsulated or sealed off in water-tight fashion and/or to which an external electro-optical supply line can be connected in a detachable fashion, in order to supply energy to and/or control the electro-optical device. This section of the supply line is preferably connected to the electro-optical device in a detachable fashion, such that the device can be easily replaced, e.g., in the event of maintenance. This moreover makes the point holder particularly easy to install, as the opto-electronic device can be connected to a supply line independently of installation of the mounting device on the respective support. For example, the supply line can be connected to the electro-optical device only after provisional mounting or fastening of the glass panel on the point holder. This is particularly an advantage in difficult installation situations.

The area of the supply line and/or its lead-through passing through the first or second mounting part can be designed as a separate section or as a coherent, integrated component that can be encapsulated in the mounting part in water-tight fashion.

The section of the supply line and/or its lead-through passing through the respective mounting part can, inside and/or outside the mounting part, be provided with a further supply line section, in order to provide a continuous supply line to the opto-electronic device. The section of the supply line and/or its lead-through passing through the respective mounting part can be of non-linear design. In particular, the section of the supply line on the outer side of the housing, or its lead-through, can have a greater radial distance from the principal axis of the point holder than the radially inner end area thereof. To this end, the supply line or lead-through can be angled or bent twice in opposite directions. In the radial direction, the radially inner area of the supply line lead-through can be located at the level of the electro-optical device, or its housing, such that the electro-optical device can be electro-optically connected to the associated end of the supply line by an electro-optical lead extending at least essentially along the principal axis of the point holder. This connection can be designed as a plug-and-socket connection.

Provided between the electro-optical device, or the part thereof located in the point holder, and the first or second mounting part can be a spacer, particularly in the form of an intermediate ring, which can reach around the outside of a projection of the first or second mounting part pointing towards the inside of the point holder, or around a housing part located between the mounting parts and at least partly in the glass panel hole. This spacer can be inserted in essentially accurately fitting manner in a corresponding receptacle in an elastic pressure pad of the respective mounting part. The spacer can have a lead-through for the supply line, particularly a lead-through for the separate intermediate section of the supply line lead-through or the supply line.

The supply line and/or its lead-through preferably has an adapter connecting to the first or second mounting part, preferably in water-tight fashion, to which an external electro-optical supply line, leading away from the point holder, can be connected, e.g., in order to electro-optically supply or control the device.

A partial area of an elastic pressure pad, inserted between the second mounting part and the glass panel, can lie in sealing fashion against the supply line lead-through, which can be designed in the form of a lead-through channel. The general purpose of the elastic pressure pad is to transmit the pressure forces of the first and second mounting parts to the glass panel and avoid damage to the glass panel in the process. In the simplest case, the pressure pad can be designed as a plate or disk. The pressure pad can consist of a rubber material. Within the lead-through, the supply line can be sealed off by separate sealing means, e.g., potted in a casting resin or a plastic compound. Correspondingly, the supply line lead-through, e.g., a cable duct, can be sealed off from the component bearing it, e.g., the second mounting part, e.g., by a casting resin or a plastic compound, such that it may be possible to dispense with additional rubber seals. The pressure pad can generally extend radially outwards from the area of the first and/or second mounting part penetrated or bridged by the supply line lead-through, such that the outer side of the area of the supply line lead-through is surrounded by the elastic pressure pad.

The outer section of the supply line and/or its lead-through through the mounting part can generally can lie radially farther outwards that the inner section thereof facing the point holder.

A partial area of the supply line and/or its lead-through through the first or second mounting part is preferably located in such a way that it is located radially outwards relative to the mounting device on the outside of the housing and, on the inside of the housing, radially inwards relative to the elastic pressure pad of the respective mounting part on the glass panel, thus passing by the pressure pad in the radial direction or at least partly bridging it. The elastic pressure pad thus does not have to be penetrated by the supply line lead-through or the supply line. In this context, a projection of the mounting part pointing towards the inside of the holder, e.g., the housing part, can have a lateral recess for accommodating the supply line.

The electro-optical device can be located between the first and second mounting parts in water-tight fashion when the point holder is installed. The electro-optical device is preferably located radially inwards relative to the pressure pads facing the first and second mounting parts. This can apply inclusively of a guard device at least partly surrounding the electro-optical device, e.g., a glass guard ring.

The supply line can generally be laterally routed away from the point holder at the level of the mounting part penetrated by it, or at the level of the area of the mounting device located between the respectively associated mounting part and the supporting structure, i.e., in the space between the mounting part and the supporting structure.

The mounting device of the point holder preferably has a joint element that, for example, can connect in articulated fashion to the first or second mounting part, such that the glass panel retained by the point holder can be retained without stresses in various positions relative to the supporting structure. In this context, the first mounting part can connect to a mounting area of the second mounting part, in order to fix the glass panel between them. The joint area and the mounting area can be separated from each other by a water-tight barrier (insulating area). The water-tight barrier can, for example, be formed by an integrally molded wall area of the first or second mounting part. This avoids complex sealing off of the joint element itself in order to prevent the penetration of water or moisture into the point holder and thus create an embodiment that is particularly reliable in operation, but at the same time of simple design.

The joint element of the mounting device can be located in a receptacle, such as a blind or stepped hole of the mounting component, e.g., of the respective mounting part, and secured in it by a blocking means to prevent removal. In particular, the mounting device can be connected to the respective mounting part, particularly the second mounting part, by a universal ball joint section and, in this context, secured on it by a blocking means. In this context, the blocking means can narrow the receptacle for the joint element, preventing removal of the joint element. In particular, the blocking means can be designed as a preferably flexible and compressible blocking ring. The blocking ring can surround, at least over part of its circumference or preferably essentially completely, a retaining bolt of the mounting device acting on the universal ball joint, and can have a smaller inside diameter than the outside diameter of the universal ball joint section. In this context, seals that seal off the respective mounting part relative to the glass panel, and/or seal off the supply line or its lead-through towards the outside, can generally be located outside the articulated joint.

Particularly when designed as a universal ball joint section, the joint element can preferably be fixed in position by a locking means relative to the point holder or the second mounting part, facing towards the supporting structure. The locking means can act on the joint element transversely, particularly perpendicularly, to the longitudinal direction of the mounting structure, or from the side of the first mounting part. The locking means is readily accessible as a result. If the locking means acts on the joint element, there is preferably an abutment that rests against the joint element and absorbs the forces exerted by the locking means. If the locking means acts transversely on the joint element, designed as a universal ball joint section, for example, the abutment can be designed as a section of the inside surface of a sphere that can extend in the ball half lying opposite the locking means and constitute an area of this ball half. If the locking means acts on the joint element from the side of the first mounting part, the abutment can simultaneously be designed as a blocking means securing the joint element against removal from its receptacle, particularly as a blocking ring. The blocking means can additionally be secured in its receptacle by locking the locking means. In this context, the joint element or the universal ball joint section can act on the blocking means in linear form. The contact line of the blocking means on the joint element or the universal ball joint section can be chamfered in order to widen the contact area. The blocking means can generally be located in a groove running around at least part of the circumference of the opening of the joint receptacle.

The locking means can generally be designed as a grub screw or retaining pin that is pressed against the joint element for locking. The locking means can be designed in such a way that it can be fixed in or on the second mounting part from the side of the second mounting part facing the first mounting part, e.g., inserted into a hole in it, particularly screwed into it. As a result, the locking means can be located and fixed on the second mounting part independently of the first mounting part. Following locking, the two mounting parts can then be fixed on each other to mount the glass panel. In this context, the first mounting part preferably covers the locking means on the outside. Alternatively, the locking means can also be inserted into the locking means receptacle of the second mounting part through a lead-through opening in the first mounting part. In this context, the forces acting on the locking means when locking can be absorbed by the first and/or second mounting part.

The locking means is preferably designed in such a way that it can be actuated when the glass panel is mounted on the point holder, particularly in such a way that the electro-optical device does not have to be moved from its target position in order to actuate the locking means. To this end, the locking means, or an insertion area thereof, can reach through the electro-optical device to act on the associated mounting part.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is an exploded lateral view of a first embodiment of a point holder according to the invention;

FIG. 2 is a view of the point holder according to FIG. 1 in assembled state; and

FIG. 3 is an exploded lateral view of a further embodiment of a point holder according to the invention.

### DETAILED DESCRIPTION OF THE INVENTION

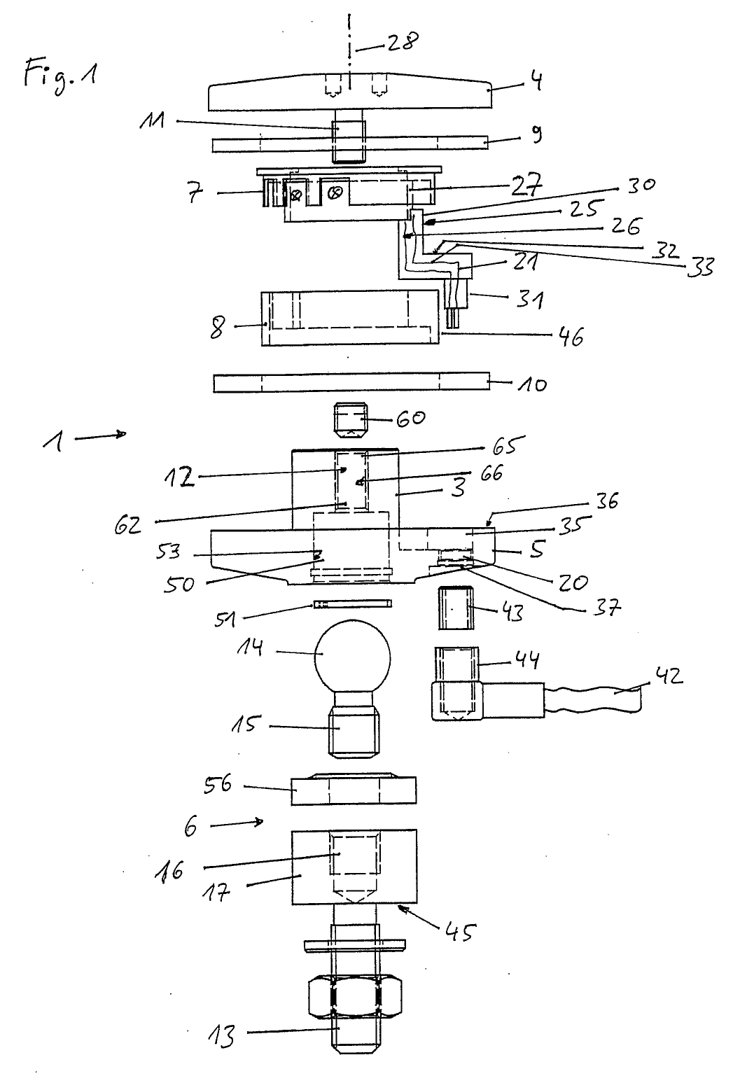

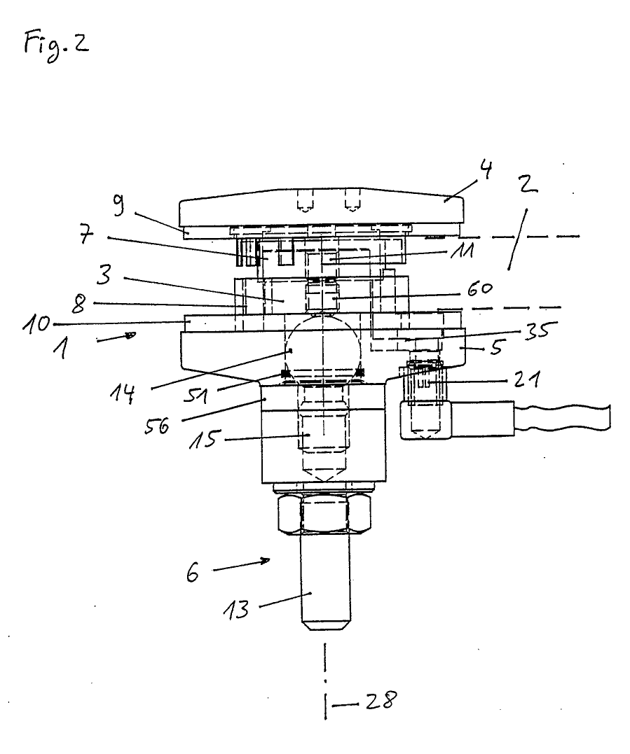

The point holder 1 according to FIGS. 1 and 2, which serves to mount a glass panel 2 provided with a hole, can have a housing part 3 that is at least partly located in the glass panel hole. The point holder can have a first mounting part 4, reaching over a front edge of the glass panel hole, and a second mounting part 5, reaching over a rear edge of the glass panel hole. Where appropriate, a housing part located partly in the glass panel hole can be dispensed with, insofar as first and second mounting parts 4, 5 can connect to each other with a force that securely retains the glass panel. Where appropriate, the housing part can also be permanently fastened to the first mounting part. The respective mounting part 4, 5 can be integrally molded on housing part 3, or fastened to it in a detachable fashion, insofar as one of the two mounting parts is fastened in detachable fashion, preferably first mounting part 4. Further provided is a mounting device 6 for fastening point holder 1 in load-transmitting fashion to a supporting structure, such as a masonry wall, facade, railing or the like, which can be fastened to one of the mounting parts, particularly second mounting part 5, and/or housing part 3.

Further provided is an opto-electronic device 7, which can be located on point holder 1, or integrated in it, and which, according to the embodiment, constitutes a lighting device that radiates light into the glass panel, e.g., laterally. Where appropriate, the opto-electronic device can also be located directly on the glass panel, e.g., between several panels of a laminated glass panel. The electro-optical device located or integrated in the point holder can generally consist essentially of the connecting part of the opto-electronic device located on the glass panel. In this instance, electro-optical device 7 is of annular design and surrounds the outside of housing part 3, more precisely in the gap between housing part 3 and the wall of the glass panel hole. Furthermore, a spacer 8 can be located between device 7 and one of the two mounting parts, such that, when the point holder is installed, device 7 is located in the glass panel hole preferably with virtually no play, or with only little play. Spacer 8 can laterally center the glass panel relative to the point holder. Where appropriate, device 7 can also be integrated in the spacer.

Furthermore, first and second mounting parts 4 and 5 are each assigned an elastic pressure pad 9, 10, which is designed in the form of a rubber washer in this instance. When point holder 1 is installed, glass panel 2 is located between these two pressure pads 9, 10, which transmit the pressure forces of mounting parts 4, 5 to the glass panel, in order to retain it securely. In this context, the pressure force can be achieved by fixing fastening element 11 of the first mounting part on the corresponding fastening area 12 of another component, such as housing part 3, e.g., by screwing the threaded stem of the first mounting part into a corresponding hole in housing part 3 or mounting part 5, or in another suitable way.

Mounting device 6 can have a fastening bolt 13, or another suitable fastening means, that can be connected to a supporting structure (not shown) in load-transmitting fashion. The bolt can connect to a joint element 14, which is designed as a universal ball joint section in this instance and can be connected to fastening bolt 13 in detachable or non-detachable fashion. According to the embodiment, joint element 14 is to this end provided with a fastening projection 15 in the form of a threaded section that can be fastened in load-transmitting fashion to a fastening means 16 of fastening bolt 13, in this instance a threaded hole of flange 17, which is connected to the fastening bolt. Joint element 14 can be secured in a receptacle 50 of second mounting part 5 and/or of housing part 3, or also of first mounting part 4 where appropriate, by appropriate securing means to prevent removal. It goes without saying that the joint element can, where appropriate, also be designed in a different way and connect to at least one of the two mounting parts, in order to allow a certain degree of movement of the glass panel mounted on the point holder.

To enable flexible handling and a simple design of the point holder, which can also be used at high ambient humidity levels, a lead-through 20 for supply line 21 for operating opto-electronic device 7 is located on second mounting part 5, outside load-transmitting mounting device 6. Independently of this, lead-through 20 for supply line 21 can particularly be located outside the articulated joint of mounting device 6 and/or the area of the point holder connecting to it in articulated fashion, particularly first or second mounting part 4, 5 and/or housing part 3. The joint element of the mounting device can generally be designed in the form of a universal ball joint section.

According to FIG. 1, electro-optical device 7 can connect to a section 25 of the supply line lead-through in which a corresponding supply line section 26 is accommodated. Independently of each other, lead-through section 25 and/or supply line section 26 can in each case be connected to electro-optical device 7 or its housing in detachable or permanent fashion. The two sections can together form a single, separate component, and supply line section 25 integrated in the lead-through can be encapsulated in the lead-through section in water-tight fashion, e.g., by a casting resin or a plastic filling material. Independently of this, lead-through section 25 can be accommodated by the mounting part in water-tight fashion, particularly also in water vapor-tight fashion, particularly its outer end area 31.

Lead-through section 25 and/or supply line section 26 has an end area 30 facing towards device 7 and an end area 31 facing away from it, which can extend at least as far as close to an outlet opening of the respective mounting part, particularly of second mounting part 5, or emerge from it in installed state, in order to enable connection of a further, external supply line section. End area 30 facing towards the device can be located in a radially inward position, end area 31 facing away from the device lying in a radially outward position. Lead-through section 25 and/or supply line section 26 can in each case have a middle area 32, 33, which extends in the radial direction and can, for example, run essentially parallel to principal plane H of mounting parts 4, 5. Middle area 32, 33 of the lead-through and/or the supply line can be located in a radially running receiving channel 35 of a mounting part, which is in this instance open towards underside 36 of the mounting part. This channel section 35 runs into a lead-through opening 37 of the mounting part, such that the end of lead-through section 25 and/or of supply line section 26 is accessible from the outside of the point holder. In this context, middle areas 32, 33 of the lead-through and/or the supply line are covered towards glass panel 2 or device 7 by the pressure pad of the mounting part, such that the pressure pad can as a whole lie plane-parallel to glass panel 2, this preferably also applying in the dismantled state of point holder 1. The open side of channel 35, lying on underside 36, is thus covered by pressure pad 9. In this context, pressure pad 9 can lie against the lead-through and/or the supply line, particularly in water or fluid-tight fashion. Radially inner section 30 of the lead-through or the supply line can in this context be located radially inwards of pressure pad 9 and, where appropriate, pressure pad 9 can also have a recess, through which sections 25, 26 of the lead-through and/or the supply line are passed. Radially outer section 31 of the lead-through and/or the supply line can in this context be located at the level of pressure pad 9, 10 in the radial direction. According to the embodiment, the lead-through and/or the supply line thus emerges to the outside on upper side 40 of the respective mounting part, although they can also be led out on lateral surface 41 of the mounting part where appropriate, in which case the above description can apply accordingly, particularly the location of sections 25 and/or 26 in relation to the pressure pad.

Device 7 can be connected to supply line section 26 by a plug-and-socket connection, for which purpose a lead 27 can be located on device 7 in the form of a projection that can, for example, extend at least essentially parallel to principal axis 28 of the point holder, or of mounting parts 4, 5, or of mounting device 6. The plug-and-socket connection can be made by inserting device 7 into its associated receptacle in the longitudinal direction of the point holder. End section 30 of the electro-optical supply line and/or of lead 27, facing towards electrical device 7, can pass through spacer 8, where an outward-lying wall section 46 of spacer 8 can shield the supply line section against the wall of the glass panel hole. Spacer 8 can laterally support end section 30 of the supply line. The spacer can simultaneously serve to laterally center the glass panel on the point holder.

For connecting lead-through and/or supply line section 25, 26 to an external supply line 42, an adapter 43 can be provided, which is connected to the mounting part in water-tight and/or detachable fashion and to which the external supply line can be connected in detachable and/or water-tight fashion. To this end, adapter 43 can be provided with an external thread for connection of fastening part 44 of the external supply line. The adapter can also form the external, water-tight termination of sections 25, 26 of the lead-through and/or the supply line. Where appropriate, water-tight and/or detachable connection of external supply line 42 to supply line section 26 can also be accomplished in a different manner, including directly and without provision of adapter 43 where appropriate. External supply line 42 can generally be routed laterally away from the point holder between mounting part 5 and the supporting structure or a contact area 45 of mounting device 6 on the supporting structure.

For articulated connection of mounting parts 4, 5 to the supporting structure, retaining device 6 can have a joint element 14 that is connected in articulated fashion to one of the mounting parts 4, 5 or housing part 3. To this end, the joint element can engage a receptacle 50 of a mounting part, of second mounting part 5 in this instance, where this receptacle can also partly extend into housing part 3. To secure joint element 14 against removal, a blocking means 51 is provided, e.g., in the form of a circlip, which surrounds the outside of a retaining bolt 15 located on joint element 14, and against which the joint element can be positioned, preferably in linear fashion. In this context, the blocking means can be fixed on inner wall 53 of receptacle 50 in positive and/or non-positive fashion, particularly by reaching behind a projection that can extend around part or all of the circumference of the opening of receptacle 50, in this instance by provision of groove 54, which preferably runs around the full circumference. Fastening bolt 13 can be fixed on the joint element, or its retaining bolt 15, preferably in detachable fashion, to which end fastening bolt 13 can be provided with a wider area, provided with a hole, in the form of flange 17. Joint element 14 and fastening bolt 13 can generally be rigidly connected to each other. For sealing off the articulated joint, between fastening bolt 13 and second mounting part 5 in this instance, a sealing element 56 is provided between flange 17 and the upper side of the mounting element, e.g., in the form of an elastic rubber ring that can be compressed between the components acting on it on either side in a manner forming a seal. At the same time, seal 56 can enable tilting of the joint element or the fastening bolt; where appropriate, tilting can also be enabled by a component that is independent of the seal. At the same time, the sealing element can self-center joint element 14 in its neutral position. The sealing element and/or the self-centering means can thus generally be located on the side of the locking means facing towards the supporting structure. Seal 56 thus seals off the joint area to prevent the penetration of moisture. Thus, apart from pressure pads 9, 10, only two further sealing areas are essentially required, in the form of joint seal 56 and the supply line seal, which can be provided on end section 31 or the adapter. In this context, sealing of the supply line is accomplished independently of the joint or the joint position.

For locking joint element 14 in a target position, a locking means 60 is provided, which can be designed as a grub screw, as illustrated. The direction of pressure application of locking means 60 relative to joint element 14 is in this instance essentially parallel to longitudinal axis 28 of the point holder or the longitudinal axis of mounting device 6 in its neutral position. The area of the joint element facing towards locking means 60 and/or blocking means 51 is preferably designed as a universal ball joint section in each case. This ensures that constant contact of the joint element on the locking and/or blocking means, e.g., continuous linear contact, is maintained in different pivoting positions of the joint element. The locking means can be designed in such a way that, through it, the joint element is pressed against the securing means in locking fashion, where the securing means can, in turn, at the same time be secured on the point holder, where appropriate. The locking means can be located in a corresponding receptacle 62, e.g., in the form of a threaded hole, in housing part 3 or, where appropriate, in the first or second mounting part 4, 5. This receptacle 62 can be designed as a stepped hole in relation to receptacle 50 for the joint element. Towards the outside, the locking means can be completely shielded by a component of the point holder or a separate cover, particularly by first mounting part 4.

The locking means can be designed and located in such a way that it can also be actuated when glass panel 2 is at least provisionally positioned on the point holder. To this end, the point holder can be essentially completely assembled, where the locking means becomes accessible, and can be actuated, from the side of the first mounting part after dismantling first mounting part 4. In this context, receptacle 62 for the locking means, or the end of housing part 3 facing towards the first mounting part, can extend at least partly through the glass panel hole, preferably roughly up to the side of the glass panel facing towards first mounting part 4. The locking means and first mounting part 4 and/or mounting device 6 can in each case be located coaxially to each other. Fastening means 11 of first mounting part 4, the threaded bolt in this instance, can engage the insertion area of the locking means in the component fixing it in place, housing part 3 in this instance, in this case engaging end area 65 of insertion channel 66 for the locking means, which is designed as a threaded hole. Fastening means 11 can be integrally molded on mounting part 4 or fixed to it in detachable fashion. In particular, fastening means 11 of the first mounting part and locking means 60 can also be fixed in place by the same fastening means of the corresponding component, in this instance by housing part 3 or threaded hole 12. To this end, the threaded bolt of the first mounting part and the locking means have the same thread diameter, although the diameters can also differ where appropriate, such that the insertion channel can be designed as a stepped hole. Locking means 60 and fastening means 11 of first mounting part 4 are thus located one behind the other in the longitudinal direction of the point holder, locking means 60 thus being covered by fastening means 63. Where appropriate, however, locking means 60 and fastening means 63 can surround each other radially.

For pre-mounting glass panel 2 on point holder 1, it can be positioned on pressure pad 10 of second mounting part 5, where spacer 8, or generally a lateral centering means of the glass panel that absorbs radial forces of glass panel 2 on point holder 1, can already be located on the point holder. Device 7 can likewise already be located on the point holder, or it can be fixed to it after positioning the glass panel, e.g., by inserting or screwing it into its receptacle. In this context, the face end of the device can rest against the spacer. After aligning mounting device 6 and joint element 14, the latter can be fixed in place by locking means 60. Thereafter, first mounting part 4 can be connected to second mounting part 5 to clamp the glass panel, e.g., fastening means 11 can be screwed into the threaded hole in housing part 3.

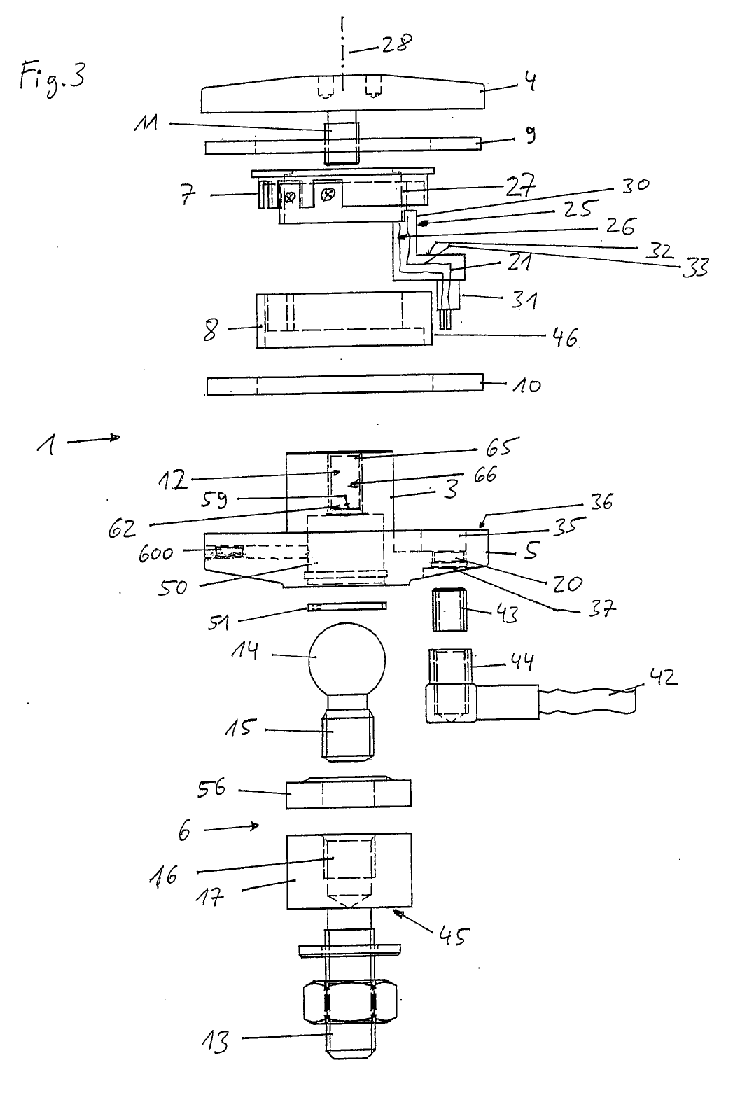

FIG. 3 shows a modification of the point holder according to FIGS. 1 and 2, the sole difference being that locking means 60 is not provided here, and joint receptacle 50 is sealed off towards first mounting part 4, in this instance by a continuous, integrally molded bottom area 59 of the receptacle. This sealing simultaneously results in water-tight sealing of the joint receptacle in relation to device 7. Where appropriate, a separate sealing element can also be present here, which can alternatively also be fixed in place in receptacle 50 from the side of the first or second mounting part 4, 5, e.g., by a sealing plate that can also be screwed into the threaded hole. Reference is made to the entire preceding description in all other respects.

It goes without saying that the locking means can optionally also be dispensed with in the embodiment according to FIGS. 1 and 2. Moreover, according to the embodiments in FIGS. 1 to 3, locking means 600 can, where appropriate, also act laterally on the joint element from the first or second mounting part 4, 5, as indicated schematically in FIG. 3. The locking means can again be a grub screw, without being limited to this.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-17. (canceled)

18. A point holder for a glass panel provided with holes, comprising a first mounting part reaching over a front edge of a glass panel hole in an installed position, a second mounting part reaching over a rear edge of the glass panel hole and, optionally, a housing part located at least partly in the glass panel hole, wherein a mounting device is provided for load-transmitting fastening of the point holder on a supporting structure, and further comprising an electro-optical device, at least a partial area of which is located on or between the first and second mounting parts, and by which energy and/or signals can be coupled into the glass panel and/or an area around the point holder, and an electro-optical supply line, and wherein the first or second mounting part, or both mounting parts, have a lead-through for the supply line, the lead-through being located outside the load-transmitting mounting device.

19. The point holder according to claim 18, wherein the mounting device is, at least in an unlocked state, designed in articulated fashion relative to the second mounting part by an articulated joint, to enable articulated movement of the supporting structure relative to the second mounting part, and wherein the lead-through for the electro-optical supply line is located outside the articulated joint of the mounting device and the second mounting part.

20. The point holder according to claim 18, wherein the supply line lead-through, through the first or second mounting part to the electro-optical device, is of water-tight design.

21. The point holder according to claim 18, wherein the first and the second mounting parts are each assigned an elastic pressure pad, located between the respective mounting part and the glass panel, and wherein a section of the electro-optical supply line at least partly bridges the pressure pad in a radial direction.

22. The point holder according to claim 21, wherein the section of the electro-optical supply line at least partly bridges the pressure pad on an outer side thereof.

23. The point holder according to claim 18, wherein the electro-optical supply line is, at least in sections, routed in a channel located in the first or second mounting part and extending in a radial direction.

24. The point holder according to claim 23, wherein the channel is, on one side, at least partly covered by an elastic pressure pad located between the mounting part and the glass panel.

25. The point holder according to claim 18, wherein a section of the supply line routed to an outside of the point holder is designed separately from the electro-optical device, and connecting elements are provided, on one hand for electro-optical connection to the device and, on another hand, on the outside of the point holder for connection to an external, further supply line section.

26. The point holder according to claim 18, wherein, on one mounting part, the supply line emerges from the point holder on a side facing away from an opposite mounting part and is preferably routed laterally away from the point holder.

27. The point holder according to claim 19, wherein the articulated joint can be fixed in position relative to one of the mounting parts by a locking means, and wherein the locking means acts on the joint element transversely to a longitudinal direction of the mounting structure, or from a side of the joint element facing towards the first mounting part.

28. The point holder according to claim 19, wherein the articulated joint can be fixed in position relative to one of the mounting parts by a locking means, and wherein the locking means is covered by the first mounting part on the outside.

29. The point holder according to claim 19, wherein the articulated joint can be fixed in position relative to one of the mounting parts by a locking means, and wherein the locking means and a fastening means for fixing the first mounting part and/or a fastening means for fixing the second mounting part on the point holder are located coaxially to each other in a longitudinal direction of the point holder.

30. The point holder according to claim 19, wherein the articulated joint can be fixed in position relative to one of the mounting parts by a locking means, and wherein the locking means and a fastening means for fixing the first mounting part on the point holder are accommodated by a same component or a same receptacle of the component retaining them.

31. The point holder according to claim 19, wherein the articulated joint is secured by blocking means in a receptacle of the point holder, and wherein the locking means presses a part area of the articulated joint against the blocking means to lock it.

32. The point holder according to claim 31, wherein the blocking means is detachably fastened.

33. The point holder according to claim 19, wherein, on a side facing away from the glass panel, the articulated joint is sealed off by a seal enabling articulated movement of the supporting structure relative to the second mounting part.

34. The point holder according to claim 19, wherein the articulated joint is separated from the electro-optical device or the first mounting part by a water-tight insulating area.

35. The point holder according to claim 18, wherein the mounting device has a joint element that connects to the second mounting part in articulated fashion, wherein the first mounting element has a fastening means for fixing the mounting part on the point holder, and wherein a joint area and a mounting area are separated from each other by a water-tight insulating area.

36. The point holder according to claim 35, wherein the water-tight insulating area is formed by an integrally molded wall area of the first or second mounting part.

37. The point holder according to claim 18, wherein at least one electro-optical supply line is accommodated in the lead-through of the mounting part.
